(19) United States
(12) Patent Application Publication
(10) Pub. No.: US 2011/0007912 A1
(43) Pub. Date: Jan. 13, 2011

(54) DOUBLE INTEGRAL METHOD OF POWERING UP OR DOWN A SPEAKER

(75) Inventor: Frederick Carnegie Thompson, Limerick (IE)

Correspondence Address: FISH & RICHARDSON P.C. (BO), P.O. BOX 1022, MINNEAPOLIS, MN, 55440-1022, US

(73) Assignee: MEDIATEK SINGAPORE PTE. LTD., Singapore (SG)

(21) Appl. No.: 12/498,745

(22) Filed: Jul. 7, 2009

(51) Int. Cl. H04B 15/00

(52) U.S. Cl. 381/94.5

(57) ABSTRACT

An audio subsystem having a waveform generation circuit that generates a power-up signal for controlling an electric signal used to drive a speaker during a power-up period in which the power-up signal has a positive second derivative during a first sub-period of the power-up period and has a negative second derivative during a second sub-period of the power-up period. The first sub-period spans at least one-fourth of the power-up period, and the second sub-period spans at least one-fourth of the power-up period.

### BACKGROUND

This description relates to powering up or down of speakers.

In some examples, when a power amplifier is switched on to drive a speaker, the power amplifier may output a power-up transient that can cause a pop or click sound to be heard on the speaker. Similarly, a power-down transient may be generated when the power amplifier is switched off, which can also cause a pop or click sound to be heard on the speaker. Portable devices, such as mobile phones, often alternates between normal operation mode and standby mode to conserve power, and the speakers of the portable devices may generate pop or click sounds when the portable device switch between standby-mode and normal operation mode. Non-portable devices, such as a home stereo systems, may also produce the pop or click sounds on power-up or down.

### SUMMARY

In general, in one aspect, an apparatus includes an audio subsystem having a waveform generation circuit that generates a power-up signal for controlling an electric signal used to drive a speaker during a power-up period. The power-up signal has a positive second derivative during a first sub-period of the power-up period and has a negative second derivative during a second sub-period of the power-up period. The first sub-period spans at least one-fourth of the power-up period, and the second sub-period spans at least one-fourth of the power-up period.

Implementations of the apparatus may include one or more of the following features. The power-up signal can increase from a ground voltage level to a common mode voltage level during the power-up period.

The waveform generation circuit can control the power-up signal such that an absolute value of the positive second derivative approximately matches an absolute value of the negative second derivative.

The waveform generation circuit can control the power-up signal such that |D1−D2|<(|D1+D2|/4), D1 representing the absolute average value of the second derivative of the power-up signal during the first sub-period, and D2 representing the absolute average value of the second derivative of the power-up signal during the second sub-period.

The waveform generation circuit can include a voltage controlled current source that receives an input voltage and generates an output current, the input voltage being proportional to the power-up signal during the first sub-period, and the waveform generation circuit uses a current proportional to the output current of the voltage controlled current source to control the electric signal used to drive the speaker.

The audio subsystem can include a speaker driver, and the power-up signal can control the speaker driver to generate the electric signal to have a waveform that corresponds to the waveform of the power-up signal.

The waveform generation circuit can include a digitally controlled voltage source that generates the power-up signal, the digitally controlled voltage source being programmed to cause the power-up signal to have a positive second derivative during the first sub-period of the power-up period.

The waveform generation circuit can control the power-up signal to switch between having a positive second derivative and having a negative second derivative based on a comparison of the power-up signal and a threshold value.

The waveform generation circuit can control a switch based on a comparison of the power-up signal and a threshold value to connect a terminal of a capacitor used to hold the power-up voltage to a constant voltage source having a voltage level equal to a common mode voltage.

The waveform generation circuit can control the power-up signal such that the second derivative of the power-up signal during the first sub-period varies by less than 50% relative to an average value of the second derivative of the power-up signal during the first sub-period.

The waveform generation circuit can control the power-up signal such that the second derivative of the power-up signal during the second sub-period varies by less than 50% relative to an average value of the second derivative of the power-up signal during the second sub-period.

The audio subsystem can be configured to, after the power-up period, drive the speaker using an audio signal.

The waveform generation circuit can generate a power-down signal for controlling the electric signal used to drive the speaker during a power-down period. The power-down signal can have a negative second derivative during a first sub-period of the power-down period and can have a positive second derivative during a second sub-period of the power-down period. The first sub-period can span at least one-fourth of the power-down period, and the second sub-period can span at least one-fourth of the power-down period.

The power-down signal can decrease from a common mode voltage level to a ground voltage level during the power-down period.

The waveform generation circuit can control the power-down signal such that the second derivative of the power-down signal during the first sub-period varies by less than 50% relative to an average value of the second derivative of the power-down signal during the first sub-period.

The waveform generation circuit can control the power-down signal such that the second derivative of the power-down signal during the second sub-period varies by less than 50% relative to an average value of the second derivative of the power-down signal during the second sub-period.

In general, in another aspect, an apparatus includes an audio subsystem having a waveform generation circuit that generates a power-down signal for controlling an electric signal used to drive a speaker during a power-down period. The power-down signal has a negative second derivative during a first sub-period of the power-down period and has a positive second derivative during a second sub-period of the power-down period. The first sub-period spans at least one-fourth of the power-down period, and the second sub-period spans at least one-fourth of the power-down period.

In general, in another aspect, an apparatus includes an audio subsystem that has a waveform generation circuit that generates a power-up signal for controlling an electric signal used to drive a speaker during a power-up period and the power-up signal has a positive second derivative during a first portion of the power-up period and has a negative second derivative during a second portion of the power-up period. The second derivative of the power-up signal deviates not more than 50% of an average of the second derivative during the first portion of the power-up period and the second derivative of the power-up signal deviates not more than 50% of an average of the second derivative during the second portion of the power-up period.

In general, in another aspect, a method includes using a power-up signal to control an electric signal used to drive a speaker during a power-up period of an audio subsystem. The power-up signal has a positive second derivative during a first sub-period of the power-up period and has a negative second derivative during a second sub-period of the power-up period. The first sub-period spans at least one-fourth of the power-up period, and the second sub-period spans at least one-fourth of the power-up period. An audio signal is sent from the audio subsystem to the speaker after the power-up period.

Implementations of the method may include one or more of the following features. The method can include controlling the power-up signal such that |D1−D2|<(|D1+D2|/4), D1 representing an absolute average value of the second derivative of the power-up signal during the first sub-period and D2 representing an absolute average value of the second derivative of the power-up signal during the second sub-period.

The method can include switching the power-up signal between having a positive second derivative and having a negative second derivative based on a comparison of the power-up signal and a threshold value.

The method can include using a power-down signal to drive the speaker during a power-down period of the audio subsystem, the power-down signal having a negative second derivative during a first sub-period of the power-down period and having a positive second derivative during a second sub-period of the power-down period, the first and second sub-periods each spanning at least one-fourth of the power-down period.

The method can include controlling the power-up signal such that the second derivative of the power-up signal during the first sub-period varies by less than 50% relative to an average value of the second derivative of the power-up signal during the first sub-period.

Advantages of the aspects, systems, and methods may include one or more of the following. During power-up and power-down, the AC coupled speaker produces a muffled sound rather than a sharp click or pop sound. Large coupling capacitors can be used to provide low cut-off frequencies while not causing large click or pop sounds during power up or down.

### DESCRIPTION OF DRAWINGS

FIG. 1 is a graph showing speaker cone deflection versus speaker coil current.

FIG. 2 is a diagram of an example audio subsystem driving an AC coupled speaker.

FIG. 3 is a graph showing an example current waveform during power up.

FIG. 4 is a graph showing an example voltage waveform during power up.

FIG. 5 is a graph showing an example current waveform during power down.

FIG. 6 is a diagram of an example power up/down waveform generation circuit.

FIG. 7 shows timing diagrams of example signals in an audio subsystem.

FIG. 8A is a graph showing an example voltage waveform.

FIG. 8B is a graph showing an example current waveform.

FIG. 9 is a diagram of an example system having a pair of AC coupled speakers.

### DETAILED DESCRIPTION

A power up/down transient waveform generator is provided to enable driving of a speaker in a way to reduce click or pop noise during power up or down of a speaker amplifier. During a power-up period where an AC coupled speaker is driven from ground (e.g., 0V) to a common mode level, a current that is increasing at a substantially constant rate is used to drive the speaker coil for a first half of the power-up period, and a current that is decreasing at a substantially constant rate is used to drive the speaker coil for a second half of the power-up period. Similarly, during a power-down period where the AC coupled speaker is driven from the common mode level to ground (e.g., 0V), a negative current that is increasing at a substantially constant rate is used to drive the speaker coil for a first half of the power-down period, and a negative current that is decreasing at a substantially constant rate is used to drive the speaker coil for a second half of the power-down period. This way, the speaker cone moves at a substantially constant rate and does not move abruptly, and produces a muffled sound, rather than a sharp click or pop sound, during the power-up and power-down periods.

### Overview

In some implementations, a speaker includes an electromagnet formed by a coil that is positioned in a constant magnetic field generated by a permanent magnet. The coil is connected to a speaker cone. By varying the current flowing through the coil, the magnetic field generated by the electromagnet interacts with the magnetic field from the permanent magnet, causing the coil to be pushed or pulled. The coil in turn pushes or pulls the speaker cone, vibrates the air in front of the speaker, and generates sound waves. The frequency and amplitude of the current signal determines the rate and distance that the coil moves, which in turn determines the frequency and amplitude of the sound waves produced by the speaker cone.

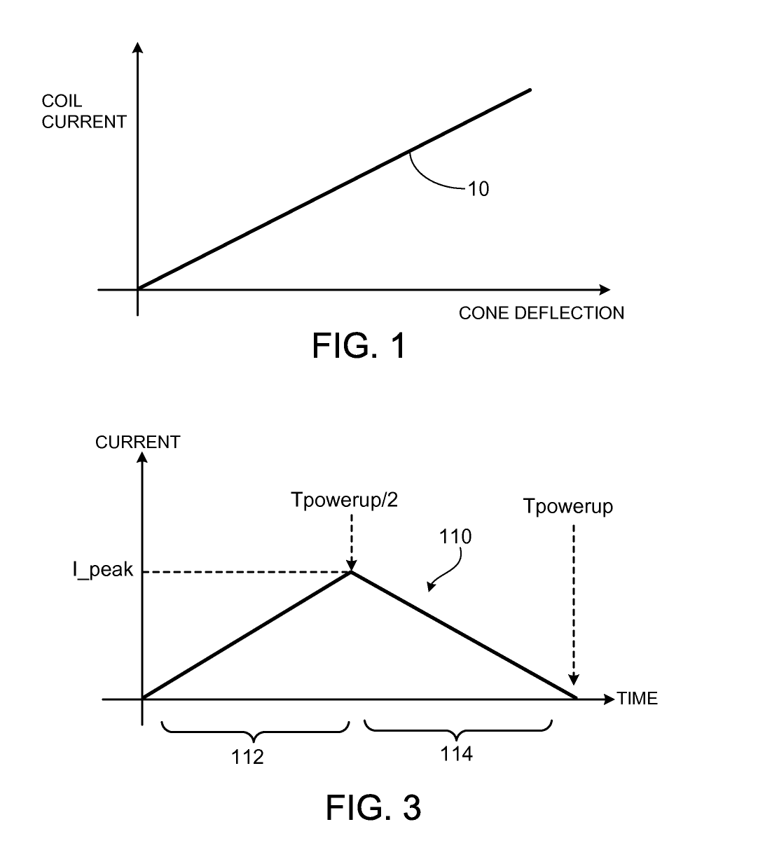

Referring to FIG. 1, a speaker cone moves in proportion to the amount of current in the speaker coil, as represented by a curve 10. As the current changes in the speaker coil, the speaker cone moves and generates sound. The speed of cone movement can convey both frequency and amplitude information.

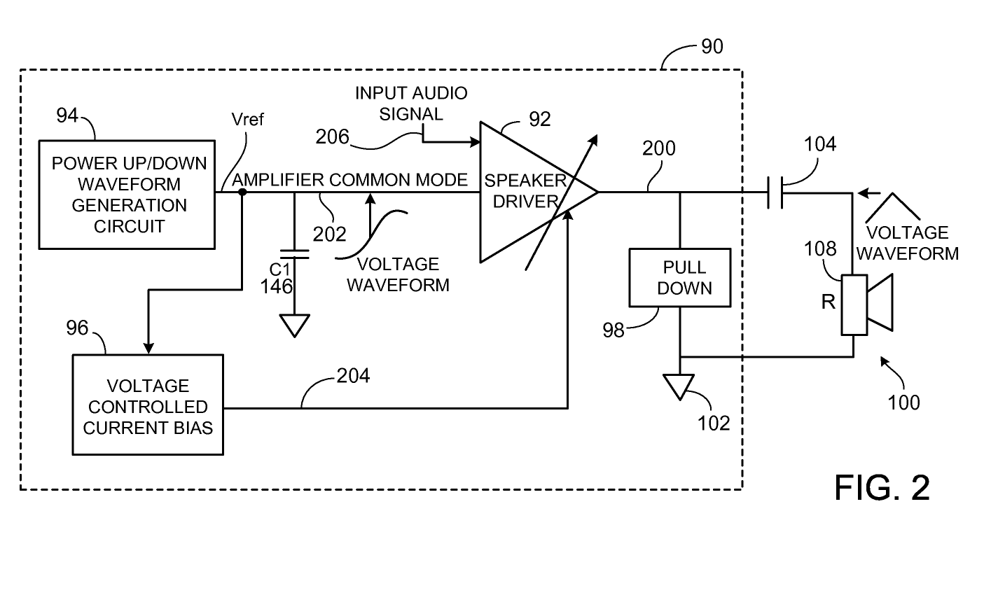

Referring to FIG. 2, in some examples, an audio subsystem 90 drives a speaker 100 through a coupling capacitor C 104. The speaker 100 has a speaker coil 108 having an impedance R. This speaker configuration is referred to as “AC coupled speaker.” The speaker coil 108 has one end connected to ground 102 and another end connected to the coupling capacitor C 104. An advantage of an AC coupled speaker is that it is not necessary to bias the other side (the side not directly receiving the input signal) of the speaker coil 108 to a common mode level, and the common mode offset does not cause additional power consumption through the speaker (because the DC current is blocked by the coupling capacitor C 104). Another advantage of an AC coupled speaker in that it is not necessary to drive the other side of the speaker to a common mode level, saving silicon area (of an integrated circuit) and current. The speaker 100 can be, e.g., part of a headphone or earpiece, or be mounted inside a portable device, such as a mobile phone, digital recorder, portable radio, or music player, or driving a speaker in a non-portable device such as a home entertainment system.

The high pass corner for the AC coupled speaker is given by the formula below:

fc=1/(2*pi*R*C)

Table 1 below shows the capacitor required to achieve various cut off frequencies for various speaker impedances.

TABLE 1
Capacitor required for speaker impedance and high pass cut off.

| | 16 ohms | 32 ohms |
|---|---|---|
| 20 Hz | 500 μF | 250 μF |
| 100 Hz | 100 μF | 50 μF |
| 300 Hz | 33 μF | 16 μF |

The current through the capacitor is given by the following formula:

i=C*d/dt*Vc(t)

This formula neglects the damping caused by the impedance R in the speaker coil 108 but is good for a first order approximation, as R is small (tens of ohms) and the voltage across the speaker remains small.

The current in the speaker coil 108 is proportional to the rate of change of the voltage applied to the capacitor, and the size of the capacitor itself. Higher quality audio systems may use speakers having lower cut off frequencies, in which the click is louder for the same speaker impedance. There is a trade off between the power up or down time allowed, the size of capacitor required, and the audibility of the click produced for a given speaker.

Upon power up of the audio subsystem 90, the output of the speaker driver 92 is raised to the common mode level of the speaker driver 92 to allow the speaker driver 92 to drive the speaker using voltage signals that swing above or below the common mode level. If the speaker driver 92 drives the output abruptly from 0V to the common mode level, a large voltage step is applied to the capacitor C in which the slope of the voltage step is limited by the slew rate of the speaker driver 92. As a result, there may be a large current step that flows through the speaker coil 108 in a very short period of time. This causes the speaker cone to have a large movement, and the rate of movement of the cone is also large. These effects can combine to make a large click or pop sound on power up.

The volume of the click sound is proportional to the rate of change of the current in the speaker coil 108. To reduce the click sound, in some implementations, the audio subsystem 90 is configured to cause the absolute rate of change of the current applied to the speaker to be substantially constant during power up. The absolute rate of change is also kept minimal while being sufficient to drive the output terminal of the audio subsystem 90 to the common mode level within a predetermined period of time.

The audio subsystem 90 includes at least one speaker driver 92, a power up/down waveform generation circuit 94, and a voltage controlled current bias 96. The speaker driver 92 generates an output signal 200 that drives the AC coupled speaker 100. In some examples, the speaker driver 92 has a digitally controlled gain. The power up/down waveform generation circuit 94 generates a voltage signal 202 that controls a common mode voltage level of the output signal 200 during power-up and power-down periods. The voltage controlled current bias 96 generates a bias current 204 for the speaker driver 92. A pull-down switch 98 is used to pull down the output voltage 200 to ground voltage after the power-down period.

During a power-up period, the following events occur. The AC gain of the speaker driver 92 is set to mute to reduce unwanted noise. The pull-down switch 98 is opened so that the output of the speaker driver 92 is not connected to ground. The power up/down waveform generation circuit 94 starts to operate and charges a capacitor C1 146 to cause the voltage signal 202 to rise from 0V to an intended common mode voltage level in which an absolute value of a second derivative of the voltage waveform is substantially constant during the power-up period. In response, the speaker driver 92 drives the voltage signal 200 from 0V to the intended common mode voltage level using the same waveform as the signal 202.

As described below, when such a voltage waveform is used to drive the AC coupled speaker 100 during the power-up period, the click or pop noise during powering up the audio subsystem 90 can be reduced. The voltage signal 202 is also sent to the voltage controlled current bias 96 to control the bias current 204 to ramp up gradually from 0 to an appropriate bias current level during the power-up period. At the end of the power-up period, the voltage of the signal 200 is at the desired common mode voltage level, the desired speaker driver gain is applied to the speaker driver 92, and the speaker driver 92 drives the speaker 100 according to an input audio signal 206.

During a power-down period, the AC gain of the speaker driver 92 is set to mute again to reduce unwanted noise. The power up/down waveform generation circuit 94 discharges the capacitor C1 146 to cause the voltage signal 202 to drop from the common mode voltage level to 0V in which the absolute value of the second derivative of the voltage waveform is substantially constant. In response, the speaker driver 92 drives the voltage signal 200 from the common mode voltage level to 0V using the same waveform as the signal 202.

When such a voltage waveform is used to drive the AC coupled speaker 100, the click or pop noise during powering down the audio subsystem 90 can be reduced. The voltage controlled current bias 96 also ramps down the bias current 204 from the common mode bias current level to 0 during the power-down period. Near the end of the power-down period, the pull-down switch 98 is closed to pull the output voltage signal 200 to ground.

FIG. 3 shows an example waveform 110 for the current that can be used to drive the speaker 100 during the power-up period Tpowerup. In this example, the current increases at a constant rate for the first half 112 of the power-up period until it reaches I_peak, then decreases at a constant rate for the second half 114 of the power-up period. The speaker cone arrives back at its resting place at the end of power up so that it can deflect equally in both directions. This spreads the power up click energy over the entire power-up period. The lower the click energy appears in the frequency spectrum, the less susceptible the listener is to hear the power up click.

In some implementations, the audio subsystem 90 is configured to power up in approximately 100 ms and be ready to drive the speaker 100 to output any audio signal. This say, the user only has to wait 100 ms after power up before hearing music or voice coming from the speaker.

The waveform 110 shows a current profile for driving the speaker 100 that provides the minimum power up click. The absolute rate of change of the current is constant and depends on the common mode level and the power up time allowed. The larger the common mode level, or the smaller the time allowed for power up, the larger the rate of change of the current and the click sound that is heard.

The coupling capacitor C 104 (FIG. 2) and the speaker coil 108 forms a high pass filter, which behaves similar to a differentiator for the voltage waveform applied across capacitor C 104 and speaker coil 108. Thus, we can integrate the current waveform to obtain the voltage waveform.

The current waveform is given by

i(t)=α*t

for 0<t<Tpowerup/2, where α is the slope of the current-versus-time curve, and

i(t)=α*Tpowerup/2−α*(t−Tpowerup/2)=α*Tpowerup−α*t

for Tpowerup/2<t<Tpowerup.

The integral of the waveform i(t) is given by

v(t)=½*α*t²

for 0<t<Tpowerup/2, and

v(t)=K+α*Tpowerup*t−½*α*t²

for Tpowerup/2<t<Tpowerup. The boundary condition is v(Tpowerup/2)=⅛*α*Tpowerup², so

K=−¼*α*Tpowerup²

and

v(t)=−¼*α*Tpowerup²+α*Tpowerup*t−½*α*t²

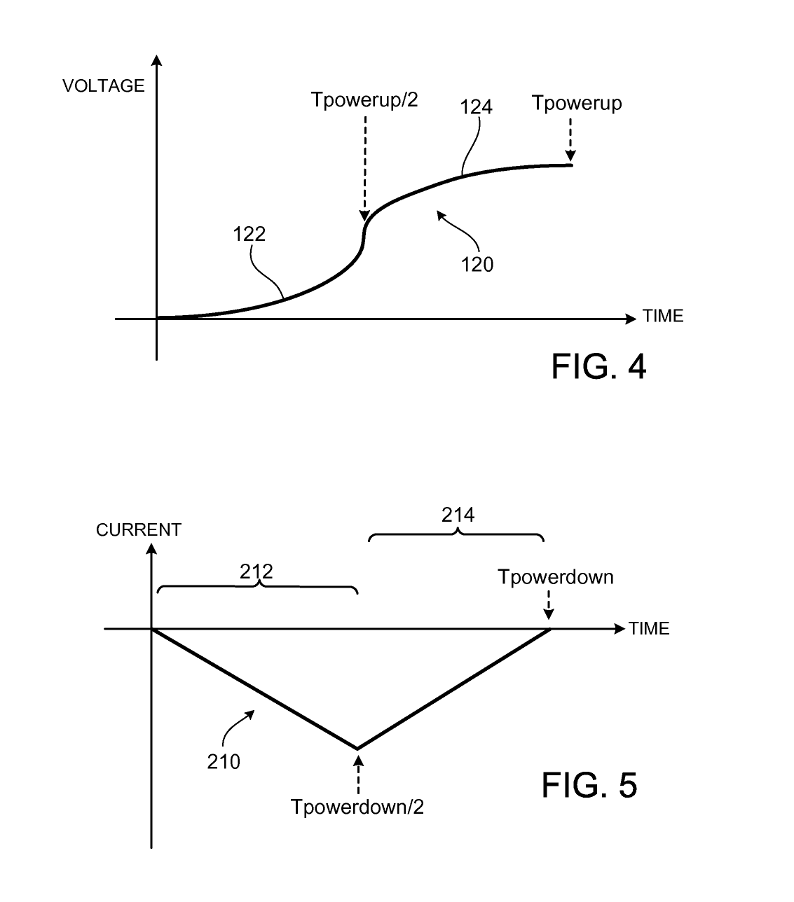

FIG. 4 shows a voltage waveform 120 applied to the coupling capacitor 104 and the speaker 100 during power up. The waveform 120 has a first portion 122 that has a positive constant second derivative (i.e., α), and a second portion 124 that has a negative constant second derivative (i.e., −α). This voltage profile provides the minimum power up click for a given AC coupling capacitor, common mode level, and power up time.

FIG. 5 shows an example waveform 210 for the current that can be used to drive the speaker 100 during the power-down period Tpowerdown. In this example, the current decreases at a constant rate for the first half 212 of the power-down period, then increases at a constant rate for the second half 214 of the power-down period. The speaker cone arrives back at its resting place at the end of the power-down period so that it does not make any more sound after powering down. This spreads the power-down click energy over the entire power-down period. The lower the click energy appears in the frequency spectrum, the less susceptible the listener is to hear the power down click.

In some implementations, the audio subsystem 90 is configured to power down in approximately 100 ms so that the system can be shut off after 100 ms. The waveform 210 shows a current profile for driving the speaker 100 that provides the minimum power down click. The absolute rate of change of the current is constant and depends on the common mode level and the power down time allowed. The larger the common mode level, or the smaller the time allowed for powering down, the larger the rate of change of the current and the click sound that is heard.

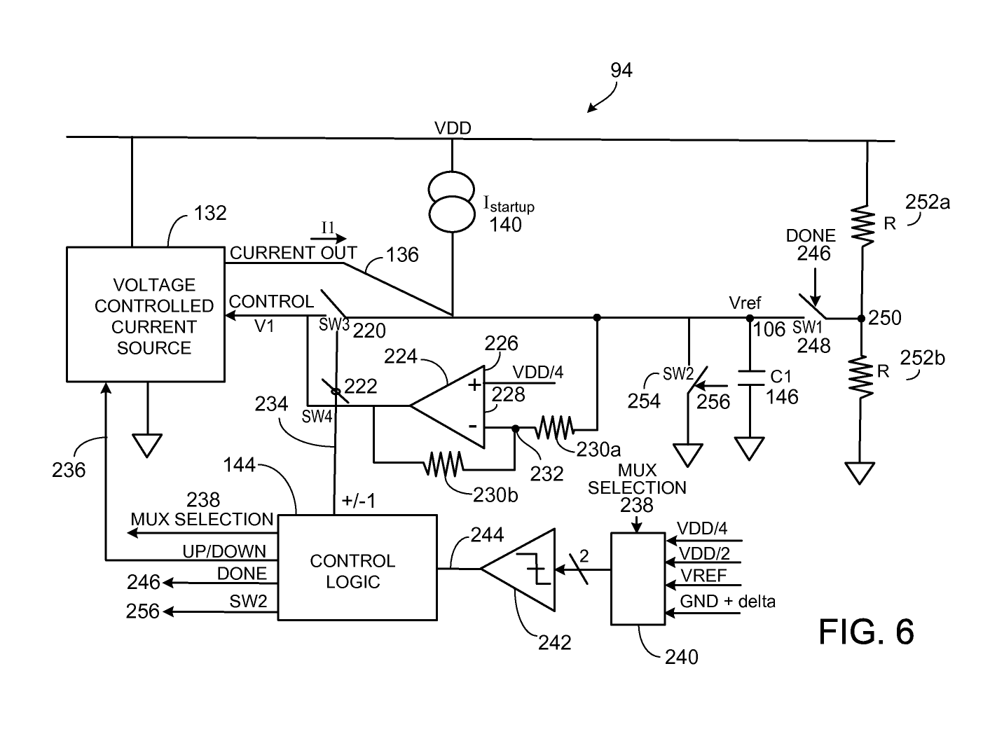

Referring to FIG. 6, in some implementations, the power up/down waveform generation circuit 94 includes a voltage controlled current source (VCCS) 132 that receives a control voltage V1 and controls a current signal I1 on a signal line 136. During a power-up period, the current I1 and the voltage V1 have the relationship I1=beta*V1, while during the power-down period, I1=−1*beta*V1. Here, beta is the VCCS gain. A control logic circuit 144 provides an Up/Down signal 236 to the VCCS 132 to indicate whether it is a power-up period or a power-down period.

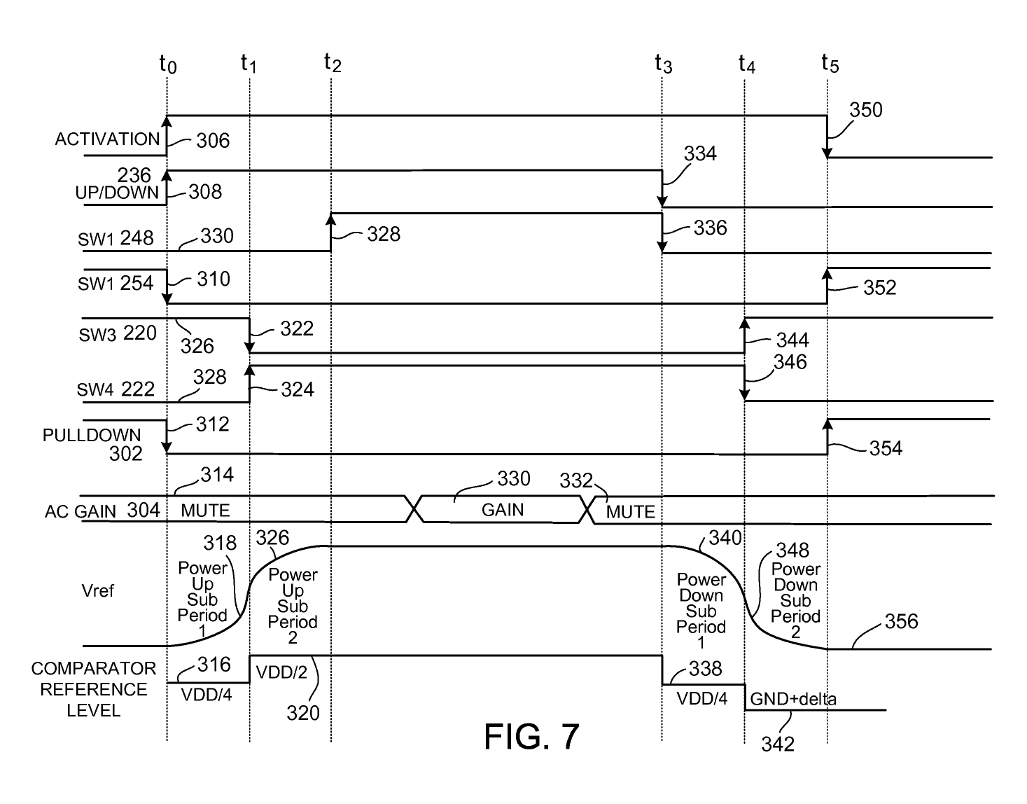

At the start of the power up period, an Activation signal (FIG. 7) changes to logic HIGH. The Activation signal is sent to the power up/down waveform generation circuit 94, the appropriate speaker driver 92, and the voltage controlled bias generator 96. The control logic circuit 144 sets the Up/Down signal 236 to logic HIGH. The control logic circuit 144 sends a control signal 234 having a “+1” state to switches SW3 220 and SW4 222 to cause the switch SW3 220 to close and the switch SW4 222 to open. This way, the output voltage Vref on an output node 106 is provided as the control voltage V1 to control the VCCS 132. The output node 106 is connected to the common mode input of the speaker driver 92 (FIG. 2). The control logic circuit 144 sends a control signal SW2 256 to open a switch SW2 254.

A start-up current source 140 outputs a small current I_startup to the Vref node 106 to start the circuit 94. The reference capacitor C1 146 integrates the charges from the current source 140 so that the output voltage Vref at a node 106 increases, which in turn increases the current I1 on line 136.

The reference capacitor 146 integrates the charges from the current sources I_startup 140 and the VCCS 132. The voltage Vref at the node 106 is given by the following equation:

Vref=(I*t)/C,

where the I includes the currents from the start up current source 140 and the VCCS 132. The Voltage Controlled Current Source 132 controls the current I1 to be proportional to V1, which is equal to the Vref voltage on node 106. The output voltage Vref increases as the output current I1 increases, which in turn increases the output current I1 further more, resulting in positive feedback in which the time constant is set by the capacitor C1 146 and the gain of the VCCS 132.

The current from the VCCS 132 is given by

$$I 1 = beta * Vref / C = beta * ( I 1 + I\_startup ) * t / C \approx beta * I 1 * t / C \qquad ( Equ . 1 )$$

where beta is the VCCS gain and C is the capacitance of C1 146. The current I_startup is small compared to I1 for most of the power-up period, and so can be ignored in the approximation above. This current is integrated on the reference capacitor C1 146, and the voltage Vref at node 106 is:

Vref=(beta*I1*t̂2)/(2*C) (Equ. 2)

The output voltage Vref depends on the charge integrated on the reference capacitor C1 146 over time due to the current from the startup current source 140 and the VCCS 132. This gives the square law relationship shown above.

The control logic circuit 144 provides a multiplexer selection signal (“Mux Selection”) 238 to a multiplexer 240 to select Vref and one of the following signals: VDD/4, VDD/2, and GND+delta, in which VDD is the power supply voltage, and delta is a small voltage. The voltages VDD/2, VDD/4, and GND+delta can be generated by using a resistor string to divide the power supply voltage VDD. The selected signals are sent to a comparator 242. During the first portion of the power-up period, Vref starts from 0V and increases. The control logic circuit 144 controls the Mux Selection signal 238 to cause the multiplexer 240 to send Vref and VDD/4 to the comparator 242.

The VCCS 132 ramps up the current I1, the reference capacitor C1 146 integrates the charges, and the output voltage Vref on node 106 increases until Vref reaches approximately VDD/4. When Vref is equal to VDD/4, the comparator 242 sends a signal 244 to the control logic circuit 144, upon which the control logic circuit 144 changes the control signal 234 to a “−1” value, which causes the switch SW3 220 to open and the switch SW4 222 to close, allowing the control voltage V1 to be driven by an amplifier 224.

The amplifier 224 has a positive input terminal 226 that receives a reference voltage VDD/4. The amplifier 224 has a negative terminal 228 that receives a voltage from a node 232 of a voltage divider made of resistors 230a and 230b. In this example, the resistors 230a and 230b have equal resistances. This configuration causes the slope of the current I1 to change to negative (i.e., I1 decreases over time). As the voltage Vref increases further, the current I1 drops. This allows the control voltage V1 to be driven to 0V as the output voltage Vref rises to VDD/2. The current I1 has a waveform similar to the waveform 110 of FIG. 3.

In this example, the common mode level is selected to be VDD/2, and the threshold for triggering the toggle of the control signal 234 from “+1” state to “−1” state, which causes the slope of the current to change from positive to negative, is set to half the common mode level or VDD/4.

The control logic circuit 144 controls the Mux Selection signal 238 to cause the multiplexer 240 to select the Vref signal and the VDD/2 signal, which are passed to the comparator 242. When the Vref signal reaches VDD/2, the comparator 242 sends a signal 244 to the control logic circuit 144, which sends a DONE signal 246 indicating that the reference voltage Vref has risen to the desired common mode voltage level. The DONE signal 246 causes a switch SW1 248 to close, connecting node 106 to a node 250 of a voltage divider that includes resistors 252a and 252b. In this example, resistors 252a and 252b have the same resistance, so the node 250 has a voltage VDD/2, which is the same voltage as the node 106 prior to closing the switch SW1 248.

In some examples, the start up current source 140, the VCCS 132, and other components are turned off. The audio subsystem 90 starts to drive the speaker 100 to generate desired audio signals.

The switches SW3 220 and SW4 222 are configured such that when the switch SW3 220 is open, the switch SW4 222 is closed, and when the switch SW3 220 is closed, the switch SW4 222 is open. In this example, the control logic 144 controls the control signal 234 to close the switch SW3 220 and open the switch SW4 222 during a first portion (e.g., approximately the first half) of the power-up period, and open the switch SW3 220 and close the switch SW4 222 during a second portion (e.g., approximately the second half) of the power-up period.

During a power-down period, the control logic circuit 144 toggles the DONE signal 246 to open the switch 248, disconnecting node 106 from node 250. The control logic circuit 144 toggles the control signal 234 to a “−1” state to cause the switch SW3 220 to open and the switch SW4 222 to close during a first portion (e.g., approximately the first half) of the power-down period. The control voltage V1 is driven by the amplifier 224. The control logic circuit 144 changes the Up/DOWN signal 236 to logic LOW so that the VCCS 132 has a negative gain, i.e., I1=−1*beta*V1. This causes the output voltage Vref to decrease from the common mode voltage level VDD/2. The current I1 is negative so electric charges are discharged from the capacitor C1146. The current I1 has a negative slope during the first portion of the power-down period, so the current decreases at about a constant rate during this period.

The control logic 144 controls the Mux Selection signal 238 to cause the multiplexer 240 to select Vref and VDD/4. When the comparator 242 detects that Vref is equal to VDD/4, the comparator 242 sends a signal 244 to the control logic circuit 144, which toggles the control signal 234 to change to the “+1” state. This causes the switch SW3 220 to close and the switch SW4 222 to open during a second portion (e.g., approximately the second half) of the power-down period. The control voltage V1 is now connected to the output voltage Vref. The current I1 gradually reduces to zero as the control voltage V1 drops to zero.

The control logic circuit 144 controls the Mux Selection signal 238 to cause the multiplexer 240 to select the Vref signal and the GND+delta signal. When the comparator 242 detects that the Vref signal has dropped to GND+delta, the control logic circuit 144 toggles the control signal SW2 256 to close the switch SW2 254, pulling the Vref signal to ground voltage level. Using this configuration, the current I1 has the waveform similar to the waveform 210 shown in FIG. 5 during power down.

FIG. 7 shows timing diagrams of example signals in the audio subsystem 90, including signals in the power up/down waveform generation circuit 94 of FIG. 6. In this example, at time t0, the Activation signal changes to logic high (306), signaling to the power up/down waveform generation circuit 94, the speaker driver 92, and the voltage controlled bias generator 96 to power up. The Up/Down signal 236 changes to logic high (308), causing the VCCS 132 to have a positive gain. The control signal applied to the first switch SW1 248 is set to logic low (330) to open the first switch SW1 248 and disconnect the capacitor C1 146 from the resistors 252a and 252b. The control signal applied to the second switch SW2 254 changes to logic low (310) to open the switch SW2 254, allowing the capacitor C1 146 to be charged.

The control signal applied to the third switch SW3 220 is set to logic high (326) to close the third switch SW3 220. The control signal applied to the fourth switch SW4 222 is set to logic low (328) to open the fourth switch SW4 222. The output voltage Vref is provided as the control voltage V1 to control the VCCS 132.

A Pulldown signal 302 is changed to logic low (312), which deactivates the pull-down switch 98 (FIG. 2) so that the pull-down switch 98 does not pull down the output voltage to ground voltage during power up. The AC gain 304 of the speaker driver 92 is set to mute (314). The multiplexer 240 selects the signal VDD/4 (316) for comparison with the output voltage Vref. During a first power up sub-period 318, the output voltage Vref increases from 0V to about VDD/4, in which the second derivative of Vref is substantially constant.

At time t1, the output voltage Vref reaches VDD/4, the multiplexer 240 selects the signal VDD/2 (320) for comparison with the output voltage Vref. The control signal applied to the third switch SW3 220 is changed to logic low (322) to open the third switch SW3 220. The control signal applied to the fourth switch SW4 222 is changed to logic high (324) to close the fourth switch SW4 222. This allows the control voltage V1 to be driven by the amplifier 224. During a second power up sub-period 326, the output voltage Vref increases from VDD/4 to approximately VDD/2, in which the second derivative of Vref is substantially constant.

At time t2, the output voltage Vref reaches VDD/2, the control signal applied to the first switch SW1 248 changes to logic high (328). This causes the capacitor C1 146 to be connected to the resistors 252a and 252b. Afterwards, the desired speaker driver gain is applied to the speaker driver 92 (330).

Shortly prior to time t3, which is the start of the power down period, the AC gain of the speaker driver 92 is set to mute again (332). At time t3, the Up/Down signal 236 is changed to logic low (334), so that the VCCS 132 has a negative gain. The multiplexer 240 selects the signal VDD/4 (338) for comparison with the output voltage Vref. During the first power down sub-period 340, the output voltage Vref decreases from VDD/2 to about VDD/4, in which the second derivative of Vref is substantially constant.

At time t4, the output voltage Vref reaches VDD/4, the multiplexer 240 selects the signal GND+delta (342) for comparison with the output voltage Vref. The control signal applied to the third switch SW3 220 is changed to logic high (344) to close the third switch SW3 220. The control signal applied to the fourth switch SW4 222 is changed to logic low (346) to open the fourth switch SW4 222. This causes the control voltage V1 to be connected to the output voltage Vref. During the second power down sub-period 348, the output voltage Vref decreases from VDD/4 to close to ground+delta, in which the second derivative of Vref is substantially constant.

At time t5, which is at the end of the power down period, the Activation signal is changed to logic low (350), signaling to the power up/down waveform generation circuit 94, the speaker driver 92, and the voltage controlled bias generator 96 to power down. The control signal applied to the second switch SW2 254 is changed to logic high (352) to close the second switch SW2 254, pulling the Vref signal to ground voltage level (356). The Pulldown signal 302 is changed to logic high (354), which activates the pull-down switch 98 (FIG. 2) so that the pull-down switch 98 pulls down the output voltage to ground voltage after power down.

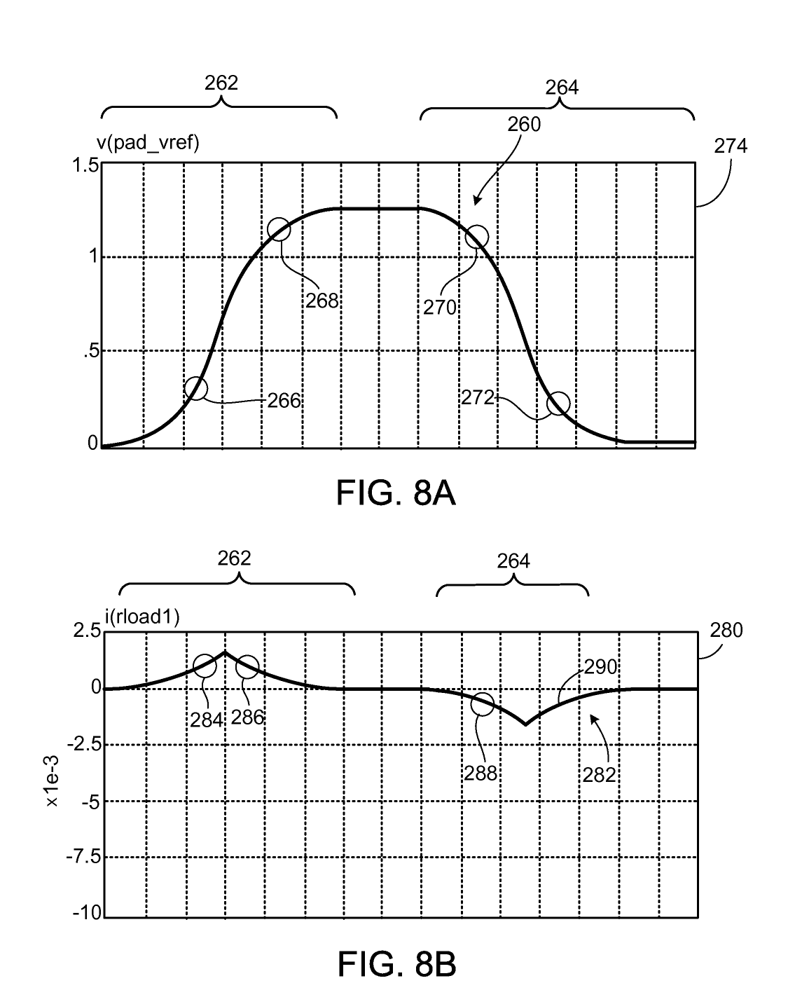

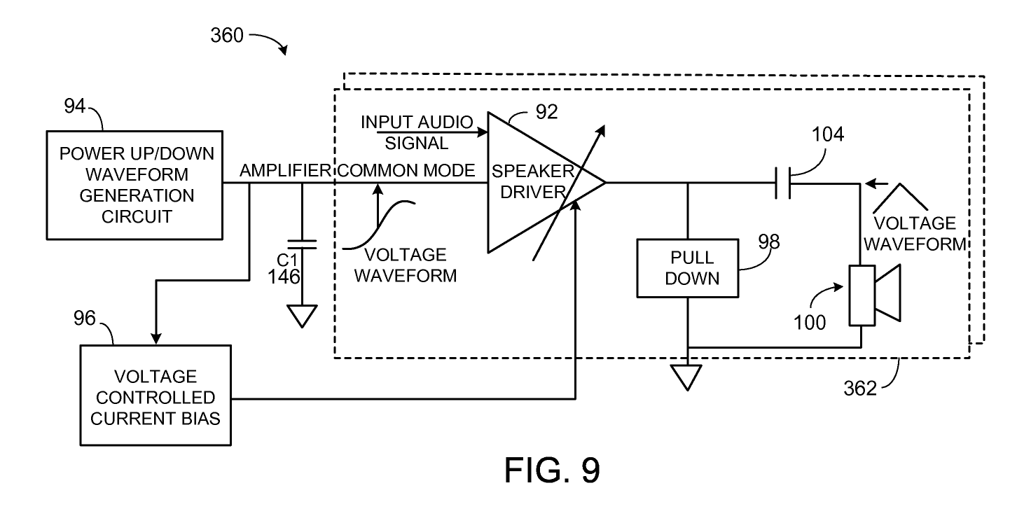

FIG. 8A is a graph 274 showing an example simulated waveform 260 for the voltage Vref output from the power up/down waveform generation circuit 94. The data for generating the waveform 260 are obtained by simulation. During a power up period 262, the voltage Vref increases from 0V to a common mode voltage level of about 1.25V. During approximately the first half of the power-up period 262, a portion 266 of the waveform 260 has a positive second derivative. During approximately the second half of the power-up period 262, a portion 268 of the waveform 260 has a negative second derivative.

During a power down period 264, the voltage Vref decreases from the common mode voltage level of about 1.25V to 0V. During approximately the first half of the power-down period 264, a portion 270 of the waveform 260 has a negative second derivative. During approximately the second half of the power-down period 264, a portion 272 of the waveform 260 has a positive second derivative.

FIG. 8B is a graph 280 showing an example simulated waveform 282 for the current provided by the speaker driver 92 to the AC coupled speaker 100. The data for generating the waveform 282 are obtained by simulation. The current is positive during the power-up period 262, and negative during the power-down period 264. During approximately the first half of the power-up period 262, the current increases from 0 to a peak current level. A portion 284 of the waveform 282 has a positive slope (or a positive first derivative). During approximately the second half of the power-up period 262, the current decreases from the peak current level to 0. A portion 286 of the waveform 282 has a negative slope (or a negative first derivative).

During approximately the first half of the power-down period 264, the current decreases from 0 to a lowest current level. A portion 288 of the waveform 282 has a negative slope (or a negative first derivative). During approximately the second half of the power-down period 264, the current increases from the lowest current level to 0. A portion 290 of the waveform 282 has a positive slope (or a negative first derivative).

The portions 284 and 286 of the waveform 282 during the power-up period 262 are similar to corresponding portions of the waveform 110 shown in FIG. 3. The slopes of the current waveform portions 284 and 286 are not entirely constant because Equations 1 and 2 above are based on approximate models of the audio subsystem 90 and speaker 100 that neglect higher order effects.

In some implementations, during the power-up period, the power up/down waveform generation circuit 94 keeps the slope of the current waveform portion 284 relatively constant such that the first derivative of the waveform portion 284 varies by less than 50%, or preferably less than 10%, relative to an average value of the first derivative of the waveform portion 284. The power up/down waveform generation circuit 94 controls the current used to drive the speaker 100 by controlling the output voltage Vref such that the second derivative of the waveform portion 266 (FIG. 7A) varies by less than 50%, or preferably less than 10%, relative to an average value of the second derivative of the waveform portion 266.

Similarly, the power up/down waveform generation circuit 94 keeps the slope of the current waveform portion 286 relatively constant such that the first derivative of the waveform portion 286 varies by less than 50%, or preferably less than 10%, relative to an average value of the first derivative of the waveform portion 286. The power up/down waveform generation circuit 94 controls the current used to drive the speaker 100 by controlling the output voltage Vref such that the second derivative of the waveform portion 268 (FIG. 7A) varies by less than 50%, or preferably less than 10%, relative to an average value of the second derivative of the waveform portion 268.

The power up/down waveform generation circuit 94 controls the current such that the absolute value of the slope of the current waveform in the portion 284 is similar to that of the portion 286. The power up/down waveform generation circuit 94 controls the output voltage Vref such that the absolute value of the second derivative of the voltage waveform in portion 266 is similar to that of the portion 268. When the absolute values of the positive second derivative approximately matches the absolute value of the negative second derivative, the first derivative of the current through the speaker 100 is made match and the speaker cone moves equally fast in both directions so that one sub-period does not cause a louder sound than the other. For example, if D1 represents the absolute average value of the second derivative of the waveform portion 266, D2 represents the absolute average value of the second derivative of the waveform portion 268, then |D1−D2|<(|D1+D2|/4), or preferably |D1−D2|<(|D1+D2|/20). This way, the speaker cone is pushed and pulled at relatively the same rate during power up, resulting in a less significant click or pop sound, as compared to driving the speaker in which the speaker cone is pushed and pulled at different rates.

The portions 288 and 290 of the waveform 282 during the power-down period 264 are similar to corresponding portions of the waveform 210 shown in FIG. 5. The slopes of the current waveform portions 288 and 290 are not entirely constant because Equations 1 and 2 above are based on approximate models of the audio subsystem 90 and speaker 100 that neglect higher order effects.

In some implementations, during the power-down period, the power up/down waveform generation circuit 94 keeps the slope of the current waveform portion 288 relatively constant such that the first derivative of the waveform portion 288 varies by less than 50%, or preferably less than 10%, relative to an average value of the first derivative of the waveform portion 288. The power up/down waveform generation circuit 94 controls the current used to drive the speaker 100 by controlling the output voltage Vref such that the second derivative of the waveform portion 270 (FIG. 7A) varies by less than 50%, or preferably less than 10%, relative to an average value of the second derivative of the waveform portion 270.

Similarly, the power up/down waveform generation circuit 94 keeps the slope of the current waveform portion 290 relatively constant such that the first derivative of the waveform portion 290 varies by less than 50%, or preferably less than 10%, relative to an average value of the first derivative of the waveform portion 290. The power up/down waveform generation circuit 94 controls the current used to drive the speaker 100 by controlling the output voltage Vref such that the second derivative of the waveform portion 272 (FIG. 7A) varies by less than 50%, or preferably less than 10%, relative to an average value of the second derivative of the waveform portion 272.

The power up/down waveform generation circuit 94 controls the current such that the absolute value of the slope of the current waveform in the portion 288 is similar to that of the portion 290. The power up/down waveform generation circuit 94 controls the output voltage Vref such that the absolute value of the second derivative of the voltage waveform in portion 270 is similar to that of the portion 272. For example, if D3 represents the absolute average value of the second derivative of the waveform portion 270, D4 represents the absolute average value of the second derivative of the waveform portion 272, then |D3−D4|<(|D3+D4|/4), or preferably |D3−D4|<(|D3+D4|/20). This way, the speaker cone is pushed and pulled at relatively the same rate during power down, resulting in a less significant click or pop sound, as compared to driving the speaker in which the speaker cone is pushed and pulled at different rates.

FIG. 9 is a diagram of an example system 360 having a pair of AC coupled speakers 100. The system 360 includes a power up/down waveform generation circuit 94, a voltage controlled current bias 96, and a capacitor C1 146, similar to those in FIG. 2. The system 360 provides a speaker driver 92 and a pull-down switches 98 for each AC coupled speaker 100 in the system 360. The box 362 shown in dashed lines enclose components that are provided for each speaker 100. In this example, there are two AC coupled speakers 100, so there are corresponding two speaker drivers 92 and two pull-down switches 98. The system 360 can be configured to drive more AC coupled speakers by adding a speaker driver 92 and pull-down switch 98 for each additional AC coupled speaker 100.

Although some examples have been discussed above, other implementations and applications are also within the scope of the following claims. For example, the various components described above may be implemented in hardware, firmware, software or any combination thereof.

The current and voltage waveforms can be generated using methods other than using the power up/down waveform generation circuit 94 in FIG. 6. For example, a data processor can output digital signals that are converted by a digital-to-analog converter to the analog current or voltage waveforms. The digital signals output from the data process are configured such that the analog current signal has a waveform with a rising slope and a decreasing slope that are as linear as possible. The digital signals do not necessarily correspond to analog a current signal with a constant first derivative or a voltage signal with a constant second derivative. The digital signals can take into account of the effects of various other components, such that when the analog signal output from the DAC is applied to the AC coupled speaker, the current flowing through the speaker coil has a constant first derivative.

What is claimed is:

1. An apparatus comprising:
an audio subsystem having a waveform generation circuit that generates a power-up signal for controlling an electric signal used to drive a speaker during a power-up period, the power-up signal having a positive second derivative during a first sub-period of the power-up period and having a negative second derivative during a second sub-period of the power-up period, the first sub-period spanning at least one-fourth of the power-up period, and the second sub-period spanning at least one-fourth of the power-up period.

2. The apparatus of claim 1 in which the power-up signal increases from a ground voltage level to a common mode voltage level during the power-up period.

3. The apparatus of claim 1 in which the waveform generation circuit controls the power-up signal such that an absolute value of the positive second derivative approximately matches an absolute value of the negative second derivative.

4. The apparatus of claim 1 in which the waveform generation circuit controls the power-up signal such that |D1−D2|<(|D1+D2|/4), D1 representing the absolute average value of the second derivative of the power-up signal during the first sub-period, and D2 representing the absolute average value of the second derivative of the power-up signal during the second sub-period.

5. The apparatus of claim 1, in which the waveform generation circuit comprises a voltage controlled current source that receives an input voltage and generates an output current, the input voltage being proportional to the power-up signal during the first sub-period, and the waveform generation circuit uses a current proportional to the output current of the voltage controlled current source to control the electric signal used to drive the speaker.

6. The apparatus of claim 1, in which the audio subsystem further comprises a speaker driver, and the power-up signal controls the speaker driver to generate the electric signal to have a waveform that corresponds to the waveform of the power-up signal.

7. The apparatus of claim 1, in which the waveform generation circuit comprises a digitally controlled voltage source that generates the power-up signal, the digitally controlled voltage source being programmed to cause the power-up signal to have a positive second derivative during the first sub-period of the power-up period.

8. The apparatus of claim 1, in which the waveform generation circuit controls the power-up signal to switch between having a positive second derivative and having a negative second derivative based on a comparison of the power-up signal and a threshold value.

9. The apparatus of claim 1, in which the waveform generation circuit controls a switch based on a comparison of the power-up signal and a threshold value to connect a terminal of a capacitor used to hold the power-up voltage to a constant voltage source having a voltage level equal to a common mode voltage.

10. The apparatus of claim 1 in which the waveform generation circuit controls the power-up signal such that the second derivative of the power-up signal during the first sub-period varies by less than 50% relative to an average value of the second derivative of the power-up signal during the first sub-period.

11. The apparatus of claim 1 in which the waveform generation circuit controls the power-up signal such that the second derivative of the power-up signal during the second sub-period varies by less than 50% relative to an average value of the second derivative of the power-up signal during the second sub-period.

12. The apparatus of claim 1 in which the audio subsystem is configured to, after the power-up period, drive the speaker using an audio signal.

13. The apparatus of claim 1 in which the waveform generation circuit generates a power-down signal for controlling the electric signal used to drive the speaker during a power-down period, the power-down signal having a negative second derivative during a first sub-period of the power-down period and having a positive second derivative during a second sub-period of the power-down period, the first sub-period spanning at least one-fourth of the power-down period, and the second sub-period spanning at least one-fourth of the power-down period.

14. The apparatus of claim 13 in which the power-down signal decreases from a common mode voltage level to a ground voltage level during the power-down period.

15. The apparatus of claim 13 in which the waveform generation circuit controls the power-down signal such that the second derivative of the power-down signal during the first sub-period varies by less than 50% relative to an average value of the second derivative of the power-down signal during the first sub-period.

16. The apparatus of claim 13 in which the waveform generation circuit controls the power-down signal such that the second derivative of the power-down signal during the second sub-period varies by less than 50% relative to an average value of the second derivative of the power-down signal during the second sub-period.

17. An apparatus comprising:
an audio subsystem, having a waveform generation circuit that generates a power-down signal for controlling an electric signal used to drive a speaker during a power-down period, the power-down signal having a negative second derivative during a first sub-period of the power-down period and having a positive second derivative during a second sub-period of the power-down period, the first sub-period spanning at least one-fourth of the power-down period, and the second sub-period spanning at least one-fourth of the power-down period.

18. An apparatus comprising:
an audio system having a waveform generation circuit that generates a power-up signal for controlling an electric signal used to drive a speaker during a power-up period, the power-up signal having a positive second derivative during a first portion of the power-up period and having a negative second derivative during a second portion of the power-up period, the second derivative of the power-up signal deviating not more than 50% of an average of the second derivative during the first portion of the power-up period, the second derivative of the power-up signal deviating not more than 50% of an average of the second derivative during the second portion of the power-up period.

19. A method comprising:
using a power-up signal to control an electric signal used to drive a speaker during a power-up period of an audio subsystem, the power-up signal having a positive second derivative during a first sub-period of the power-up period and having a negative second derivative during a second sub-period of the power-up period, the first sub-period spanning at least one-fourth of the power-up period, and the second sub-period spanning at least one-fourth of the power-up period; and
sending an audio signal from the audio subsystem to the speaker after the power-up period.

20. The method of claim 19, comprising controlling the power-up signal such that |D1−D2|<(|D1+D2|/4), D1 representing an absolute average value of the second derivative of the power-up signal during the first sub-period and D2 representing an absolute average value of the second derivative of the power-up signal during the second sub-period.

21. The method of claim 19, comprising switching the power-up signal between having a positive second derivative and having a negative second derivative based on a comparison of the power-up signal and a threshold value.

22. The method of claim 19, comprising using a power-down signal to drive the speaker during a power-down period of the audio subsystem, the power-down signal having a negative second derivative during a first sub-period of the power-down period and having a positive second derivative during a second sub-period of the power-down period, the first and second sub-periods each spanning at least one-fourth of the power-down period.

23. The method of claim 19, comprising controlling the power-up signal such that the second derivative of the power-up signal during the first sub-period varies by less than 50% relative to an average value of the second derivative of the power-up signal during the first sub-period.
